(19) United States
(12) Patent Application Publication
(10) Pub. No.: US 2018/0284870 A1
(43) Pub. Date: Oct. 4, 2018

(54) METHOD AND APPARATUS FOR ENERGY EFFICIENCY RATING EVALUATION FOR PHYSICAL SERVER

(71) Applicant: ELECTRONICS AND TELECOMMUNICATIONS RESEARCH INSTITUTE, Daejeon (KR)

(72) Inventor: Jin-Ho ON, Sejong (KR)

(21) Appl. No.: 15/865,158

(22) Filed: Jan. 8, 2018

(30) Foreign Application Priority Data
Mar. 30, 2017 (KR) 10-2017-0040441

(51) Int. Cl. G06F 1/32; G06F 9/4401

(52) U.S. Cl. CPC G06F 1/3209; G06F 9/4408

(57) ABSTRACT

Disclosed herein are a method and apparatus for automatically determining the energy efficiency and the energy rating of a target device. An apparatus for measuring energy efficiency may automatically boot and configure a target device with regard to the energy efficiency of the target device, measure the energy efficiency of the target device, and determine the energy rating of the target device. The apparatus may provide a boot image and a workload to the target device. Also, the apparatus may control the workload that is executed in the target device. The apparatus may collect information about the execution of the workload from the target device, measure the energy efficiency of the target device using the information, and determine the energy rating of the target device.

### CROSS REFERENCE TO RELATED APPLICATION

This application claims the benefit of Korean Patent Application No. 10-2017-0040441, filed Mar. 30, 2017, which is hereby incorporated by reference in its entirety into this application.

### BACKGROUND OF THE INVENTION

### 1. Technical Field

The following embodiments relate generally to a method and apparatus for evaluating energy efficiency, and more particularly to a method and apparatus for evaluating the energy efficiency of a device such as a physical server or the like.

### 2. Description of the Related Art

With an increase in the amount of energy consumed in data centers, interest in the energy efficiency ratio of server nodes is rising.

With regard to the energy efficiency of server nodes, governing bodies, such as the Standard Performance Evaluation Corporation (SPEC) and the like, have developed and provided various benchmarking tools for evaluating the energy efficiency of servers.

As representatives of standardized benchmarking tools provided by the SPEC, there are SPECPower_ssj2008, Server Efficiency Rating Tool (SERT), and the like.

Each of these tools is configured with a certified measuring device and a control server. Such a tool measures the energy efficiency of a server by measuring the amount of energy actually consumed in order to bear a load generated in the control server.

However, these tools require very complicated system setup and configuration in order to measure the energy efficiency of a specific node. Also, these tools may output different results depending on the system setup and configuration that are applied when energy efficiency is measured. In other words, the result of measurement of energy efficiency performed using such a tool may vary depending on how well a person in charge of measurement understands the system.

With regard to energy usage by a server, Korean Patent Application Publication No. 10-2013-0063882 and No. 10-2004-0055771 have been published.

The following embodiments propose a method for solving the various problems with the existing method for measuring energy efficiency.

### SUMMARY OF THE INVENTION

An embodiment may provide an apparatus and method for automatically booting and configuring a target device, measuring the energy efficiency of the target device, and determining the energy rating of the target device.

An embodiment may provide a standardized system, which may solve problems with an existing system, such as a complicated setup process, variation in results depending on a user, and the like, in an automated manner.

An embodiment may provide an apparatus and method for adding a workload for a user's purpose.

An embodiment may provide an apparatus and method through which the energy rating of a device, such as a server or the like, may be efficiently determined in accordance with a user's purpose by adding a workload.

An embodiment may provide an apparatus and method for determining the energy ratings of target devices having various architectures by registering and executing a user-specific workload or a workload standardized for various architectures.

In one aspect, there is provided a method for evaluating energy efficiency, which includes sending a workload image of a workload to a target device; and measuring an energy efficiency of the target device depending on an amount of power consumed by the target device for execution of the workload.

The method may further include determining an energy rating of the target device based on the measured energy efficiency.

The energy rating may be determined using Performance Per Watt (PPW).

The energy rating may be determined using a relative value acquired based on comparison with another device, an energy efficiency of which has previously been evaluated.

The method may further include providing the target device with a boot image including an operating system.

The operating system may be booted on the target device through a Preboot eXecution Environment (PXE).

The boot image may be selected depending on an architecture of the target device from among multiple boot images.

The method may further include performing configuration for measurement of the energy efficiency through communication with the target device when booting of the operating system is completed.

The method may further include receiving a request for the workload from the target device.

The boot image may include a Docker container.

The request for the workload may be sent from the target device when the Docker container is run on the target device after the operating system is booted.

The method may further include controlling the workload in real time such that a load factor of the workload matches a target load.

The method may further include receiving measurement information, which represents power consumption, from a power measurement device.

The method may further include receiving workload execution information, which is information about the execution of the workload, from the target device.

The measurement information and the workload execution information may be collected in real time when the workload is executed in the target device.

The energy efficiency may be measured for a workload set.

The workload set may be a combination of at least one workload for each of multiple components.

The method may further include registering a workload for a selected component.

The selected component may be one of a Central Processing Unit (CPU), memory, a network, and a Graphics Processing Unit (GPU).

The energy efficiency may be measured for each of multiple components.

The method may further include registering the workload.

The workload may include a calibration phase, a load measurement phase, and an idleness measurement phase.

A load factor in the load measurement phase and a number of times the load measurement phase is performed may be determined depending on characteristics of a component to which the workload pertains.

In another aspect, there is provided an electronic apparatus, which includes a communication unit for sending a workload to a target device; and a processing unit for measuring energy efficiency of the target device based on an amount of power consumed by the target device for execution of the workload.

In a further aspect, there is provided a measurement system, which includes an energy-rating determination apparatus for sending a workload to a target device and determining an energy rating of the target device depending on an amount of power consumed by the target device for execution of the workload; and a power measurement device for providing the energy-rating determination apparatus with measurement information about the amount of power consumed by the target device.

Additionally, other methods, devices, and systems for implementing the present invention and a computer-readable recording medium for recording a computer program for implementing the above-described methods are further provided.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the hardware configuration of a measurement system according to an embodiment;

FIG. 2 is a block diagram of an apparatus for determining an energy rating according to an embodiment;

FIG. 3 shows the configuration of an apparatus for determining an energy rating according to an embodiment;

FIG. 4 shows an image running on a target device according to an example;

FIG. 5 is a flowchart of a method for evaluating energy efficiency and determining an energy rating according to an embodiment;

FIG. 6 is a flowchart of a method for registering a target device according to an example;

FIG. 7 is a flowchart of a method for registering a workload according to an example;

FIG. 8 shows the execution of a workload according to an example;

FIG. 9 is a flowchart of a method for registering a workload set according to an example;

FIG. 10 is a flowchart of a method for measuring the energy efficiency of a target device according to an embodiment; and

FIG. 11 is a flowchart of a method for determining the energy rating of a target device according to an embodiment.

### DESCRIPTION OF THE PREFERRED EMBODIMENTS

Specific embodiments will be described in detail below with reference to the attached drawings. These embodiments are described in sufficient detail to enable those skilled in the art to practice the present invention. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present invention. Also, it should be understood that the location or arrangement of individual elements in the disclosed embodiments may be changed without departing from the spirit or scope of the present invention. Therefore, the following detailed description is not to be taken in a limiting sense, and if appropriately interpreted, the scope of the exemplary embodiments is limited only by the appended claims, along with the full range of equivalents to which the claims are entitled.

The same reference numerals are used to designate the same or similar elements throughout the drawings. The shapes, sizes, etc. of components in the drawings may be exaggerated to make the description clear.

Terms used herein are for the purpose of describing particular embodiments only and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element, or intervening elements may be present.

It will be understood that, although the terms “first,” “second,” etc. may be used herein to describe various elements, these elements should not be limited by these terms. These terms are only used to distinguish one element from another element. For instance, a first element discussed below could be referred to as a second element without departing from the teachings of the present invention. Similarly, a second element could also be referred to as a first element.

Also, element modules described in the embodiments of the present invention are independently shown in order to indicate different characteristic functions, but this does not mean that each of the element modules is formed of a separate piece of hardware or software. That is, element modules are arranged and included for convenience of description, and at least two of the element units may form one element unit, or one element may be divided into multiple element units and the multiple element units may perform respective functions. An embodiment into which the elements are integrated or an embodiment from which some elements are removed is included in the scope of the present invention, as long as it does not depart from the essence of the present invention.

Also, in the present invention, some elements are not essential elements for performing essential functions, but may be optional elements for improving only performance. The present invention may be implemented using only essential elements for implementing the essence of the present invention, excluding elements used to improve only performance, and a structure including only essential elements, excluding optional elements used only to improve performance, is included in the scope of the present invention.

Hereinafter, embodiments of the present invention are described with reference to the accompanying drawings in order to describe the present invention in detail so that those having ordinary knowledge in the technical field to which the present invention pertains can easily practice the present invention. In the following description of the present invention, detailed descriptions of known functions and configurations which are deemed to make the gist of the present invention obscure will be omitted.

The following embodiments relate to a method and apparatus for efficiently determining the energy rating of a target device, such as various physical servers used in a data center. The following embodiments may include the following:

a method for determining the energy efficiency and the energy rating of a target device using a standardized workload

a method for generating a special-purpose workload for a target device

a method for determining the energy efficiency and the energy rating of each component of a target device

a method for automatically determining the energy rating of a target device

a method for managing a target device

a method for managing a load to be used to determine an energy rating

a method for managing a system image to be used to determine an energy rating.

The method proposed in the following embodiments enables complicated system setup and load configuration, which are required for energy-rating determination, to be performed in an automated manner. Also, through the following embodiments, energy ratings may be determined from various aspects while only requiring minimal setup of a target device by a user.

The following embodiments describe a method for generating a special-purpose workload and a standardized workload for an automated method. Also, the following embodiments describe a method for applying a workload in order to determine an energy rating.

Through the following embodiments, a platform for standardized energy rating determination for energy saving may be provided.

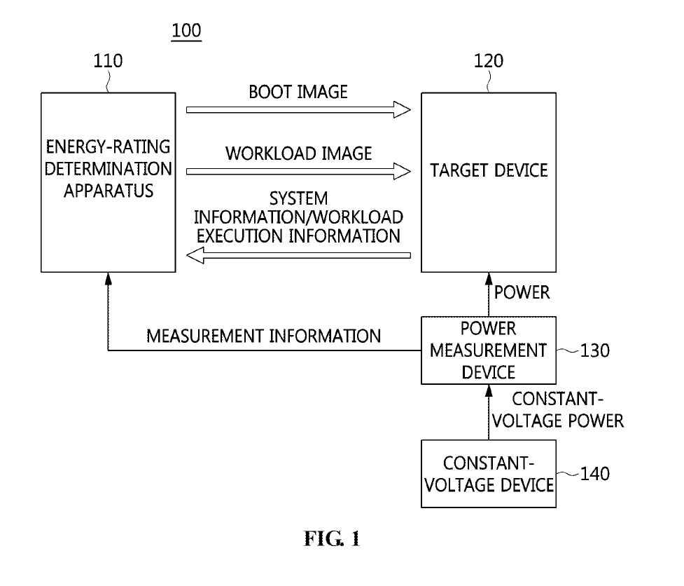

FIG. 1 shows the hardware configuration of a measurement system according to an embodiment.

The measurement system 100 may include an energy-rating determination apparatus 110, a target device 120, a power measurement device 130, and a constant-voltage device 140.

The energy-rating determination apparatus 110 may determine the energy rating of the target device 120. In order to determine the energy rating, the energy-rating determination apparatus 110 may provide a boot image and a workload image to the target device 120.

The energy-rating determination apparatus 110 may be a control server for controlling the target device 120 in order to determine the energy rating of the target device 120.

The energy-rating determination apparatus 110 may be configured based on OpenStack, and may perform tasks such as registration, measurement, evaluation, and the like in connection with the target device 120.

The target device 120 may be a device or server, the energy rating of which is to be determined. The target device 120 may be a bare metal server having no Operating System (OS) installed therein, or may be a directly used physical server.

The energy-rating determination apparatus 110 may automatically determine the energy rating of the target device 120.

In order to determine the energy rating, the target device 120 may execute a workload, and may send system information and workload execution information to the energy-rating determination apparatus 110.

The architecture of the target device 120 may be x86, ARM, ARM64, PowerPC, or the like.

The type of architecture that can be applied to the target device 120 may change depending on the architectures supported by the OS image registered in the energy-rating determination apparatus 110. The OS of the OS image may run on most architectures on which a Docker container runs.

If the target device 120 is registered in the energy-rating determination apparatus 110, the energy-rating determination apparatus 110 may boot the target device 120 using a boot image including an OS for determining an energy rating, which is registered in the energy-rating determination apparatus 110. When booting of the target device 120 has been completed, the energy-rating determination apparatus 110 may set configuration details for determination through communication with the target device 120. Through the communication between the energy-rating determination apparatus 110 and the target device 120, setting of the configuration details may be automatically completed.

When setting of the configuration details has been completed, the energy-rating determination apparatus 110 may measure the energy efficiency of the target device 120. The energy-rating determination apparatus 110 may acquire measurement information that represents the amount of power consumed by the target device 120 from the power measurement device 130.

The energy-rating determination apparatus 110 may determine the energy rating of the target device 120 using information about operations performed by the target device 120 and the amount of power consumed when the target device 120 performs the corresponding operations.

The power measurement device 130 may supply power to the target device 120, and may measure the amount of power consumed by the target device 120.

The power measurement device 130 may send measurement information, which represents the amount of power consumed by the target device 120, to the energy-rating determination apparatus 110.

Depending on the benchmark program used for a load, an authorized measurement device or an unauthorized measurement device may be used as the power measurement device 130.

The constant-voltage device 140 may supply constant voltage to the power measurement device 130.

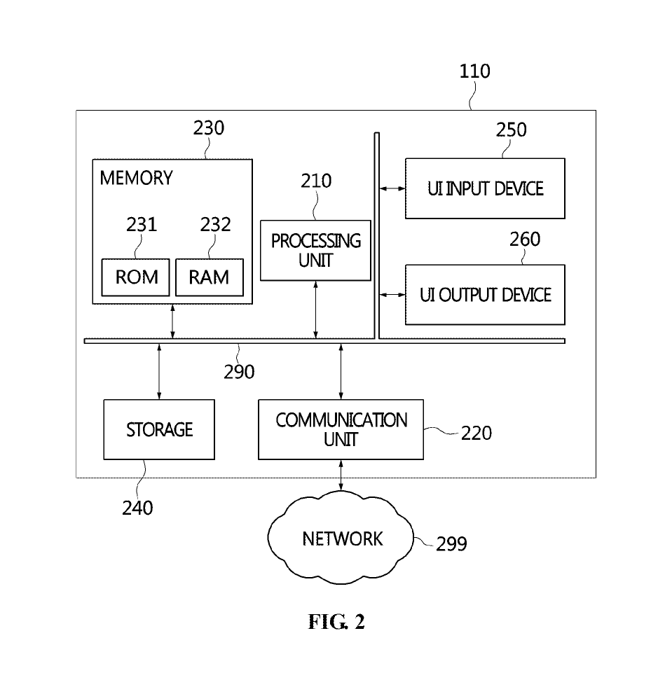

FIG. 2 is a block diagram of an apparatus for determining an energy rating according to an embodiment.

The energy-rating determination apparatus 110 may be implemented as an electronic device or a general-purpose computer system.

As illustrated in FIG. 2, the energy-rating determination apparatus 110 may include at least some of a processing unit 210, a communication unit 220, memory 230, storage 240 and a bus 290.

The components of the energy-rating determination apparatus 110, such as the processing unit 210, the communication unit 220, the memory 230, the storage 240, and the like, may communicate with each other via the bus 290.

The processing unit 210 may be a semiconductor device for executing processing instructions stored in the memory 230 or the storage 240. For example, the processing unit 210 may be at least one processor.

The processing unit 210 may process work required for the operation of the energy-rating determination apparatus 110. The processing unit 210 may execute the code of operations or steps of the processing unit 210 explained in the embodiments.

The processing unit 210 may perform the generation, storage and output of information to be explained in the following embodiment, and may additionally process the operation of steps performed in the energy-rating determination apparatus 110.

The communication unit 220 may be connected with a network 299, and may send and receive data or information required for the operation of the energy-rating determination apparatus 110. The communication unit 220 may send data to other devices and receive data from other devices via the network 299. For example, the communication unit 220 may be a network chip or port.

The memory 230 and the storage 240 may be various types of volatile or nonvolatile storage media. For example, the memory 230 may include at least one of ROM 231 and RAM 232. The storage 240 may include an internal storage medium, such as RAM, flash memory, a hard disk, or the like, and may include a removable storage medium, such as a memory card or the like.

The function or operation of the energy-rating determination apparatus 110 may be performed when the processing unit 210 executes at least one program module. The memory 230 and/or the storage 240 may store at least one program module therein. The at least one program module may be configured to be executed by the processing unit 210.

The energy-rating determination apparatus 110 may further include a User Interface (UI) input device 250 and a UI output device 260. The UI input device 250 may receive user input required for the operation of the energy-rating determination apparatus 110. The UI output device 260 may output information or data depending on the operation of the energy-rating determination apparatus 110.

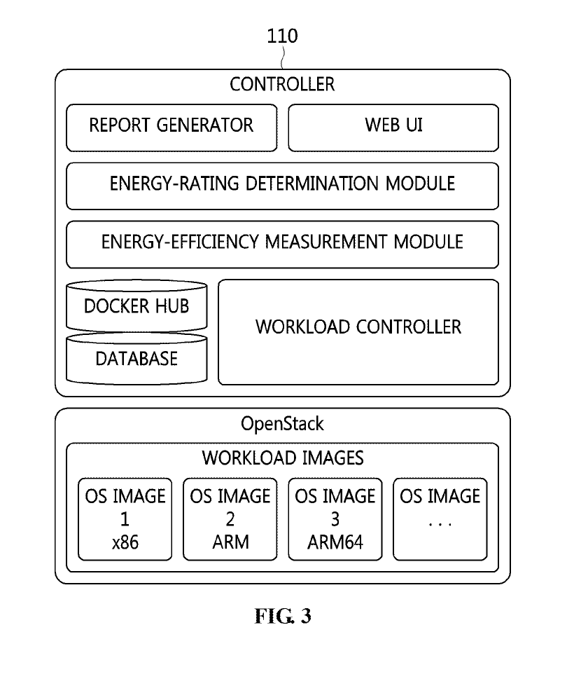

FIG. 3 shows the configuration of an apparatus for determining an energy rating according to an embodiment.

The measurement system 100 or the energy-rating determination apparatus 110 may analyze the energy efficiency of devices having different hardware architectures using standardized workloads or various workloads oriented to a user's purpose.

The measurement system 100 may classify the hardware of a device, the energy efficiency of which is to be measured, in an automated manner. The measurement system 100 or the energy-rating determination apparatus 110 may automatically classify the hardware of a device, the energy efficiency of which is to be measured, from various aspects by extending workloads and OS images that support various architectures. Here, the workloads may include a standard workload and a workload for a special purpose.

The measurement system 100 may be divided into three blocks. The three blocks may be 1) an execution system for enabling the energy-rating determination apparatus 100 to automatically determine an energy rating, 2) an image running on the target device 120, and 3) the OpenStack platform for the system automation of the energy-rating determination apparatus 110.

First, the execution system for enabling the energy-rating determination apparatus 110 to automatically determine an energy rating will be described with reference to FIG. 3.

The energy-rating determination apparatus 110 may operate as a controller.

The energy-rating determination apparatus 110 may include a report generator, a web UI, an energy-rating determination module, an energy-efficiency measurement module, a Docker hub, a database, and a workload controller. The report generator, the web UI, the energy-rating determination module, the energy-efficiency measurement module, the Docker hub, the database, and the workload controller may be at least one program module, which has been described with reference to FIG. 2.

The report generator may generate a report about the measurement of the energy efficiency of the target device 120 and the determination of the energy rating thereof.

The energy-efficiency measurement module may enable the target device 120 to execute a workload selected by a user, and may generate the energy score of the target device 120 in response to the execution of the workload. The energy score may denote the energy efficiency of the target device 120.

The energy-rating determination module may determine the energy rating of the target device 120. The energy-rating determination module may determine the energy rating of the target device 120 by processing a result output from the energy-efficiency measurement module based on an absolute or relative criterion determined by a user.

The workload controller may be executed in response to a request from the energy-rating determination module or the energy-efficiency measurement module. The workload controller may distribute a workload to the target device 120, and may enable the workload to be executed in the target device 120.

Also, the workload controller may collect data about utilization and data about power consumption at the time of executing the workload in the target device 120 using a utilization data collector and a power data collector. The workload controller may store the collected data.

The web UI may provide an interface to a user. The web UI may provide interfaces for the following functions:

1) management of the target device 120

2) management of workloads

3) analysis of energy efficiency

4) analysis of an energy rating

5) management of the power measurement device 130.

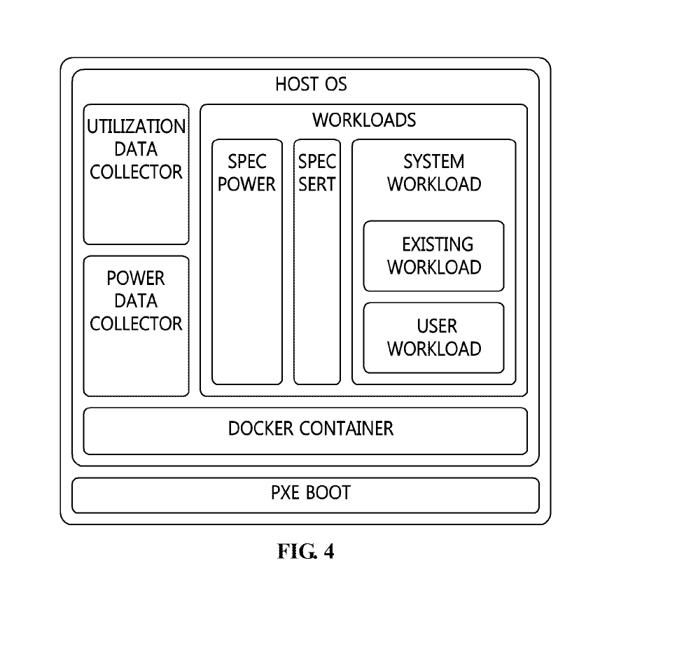

Hereinafter, an image running on the target device 120 will be described with reference to FIG. 4.

FIG. 4 shows an image running on a target device according to an example.

The image in FIG. 4 may show the state in which a boot image and a workload image, provided by the energy-rating determination apparatus 110, are running on the target device 120.

The image may include a host OS and a Preboot eXecution Environment (PXE). The host OS may represent an OS running on the target device 120.

The host OS may include a utilization data collector, a power data collector, and workloads.

For example, the workloads may include SPECPower, SPEC SERT, existing workloads, a user workload, and the like.

The utilization data collector may provide information about the utilization of the target device 120 to the energy-efficiency measurement module of the energy-rating determination apparatus 110. For example, the utilization data collector of the target device 120 may send information about the utilization of power in the target device 120 to the utilization data collector of the energy-rating determination apparatus 110.

The power data collector may provide information about power consumption by the target device 120 to the energy-efficiency measurement module of the energy-rating determination apparatus 110. For example, the power data collector of the target device 120 may send information about the amount of power consumed by the target device 120 to the power data collector of the energy-rating determination apparatus 110.

The workloads may include various benchmarks for the respective components of the target device 120. The workloads may include a standard benchmark, such as SPECPower2008_ssj or the like, and a special-purpose benchmark. The special-purpose benchmark may be registered in the energy-rating determination apparatus 110 by a user, and may then be used by the energy-rating determination apparatus 110.

Hereinafter, the OpenStack platform for the system automation of the energy-rating determination apparatus 110 will be described with reference again to FIG.

The energy-rating determination apparatus 110 may be configured based on OpenStack, and may provide the OpenStack platform.

The OpenStack platform may include an image file, a tool, a power information collection Application Programming Interface (API) and Ironic.

The OpenStack platform may provide image files of multiple OSs. Architectures supported by the OSs may differ from each other. In FIG. 3, OS image file 1, OS image file 2, and OS image file 3 are illustrated, and these image files may run on different architectures.

The image file may be a file containing a boot image that runs on the above-described target device 120. That is, a boot image that is used to boot the target device 120 may be stored as the image file in the energy-rating determination apparatus 110, or the image file may correspond to the above-described boot image.

The image file may include a power data collector for collecting information about power consumption and a utilization data collector for collecting information about utilization. Also, the image file may include a container for executing a workload.

The image file may be extended to various images depending on the architecture that can be supported.

The tool may collect data and draw a graph for the collected data. For example, the tool may be the Round-Robin Database (RRD) tool provided by the OpenStack platform.

The power information collection API may be an API that implements a function of collecting measurement information from various power measurement devices.

Ironic may provide a function of managing the target device 120, such as a bare metal server or the like. The management function may be provided using the Preboot eXecution Environment (PXE) and Intelligent Platform Management Interface (IPMI).

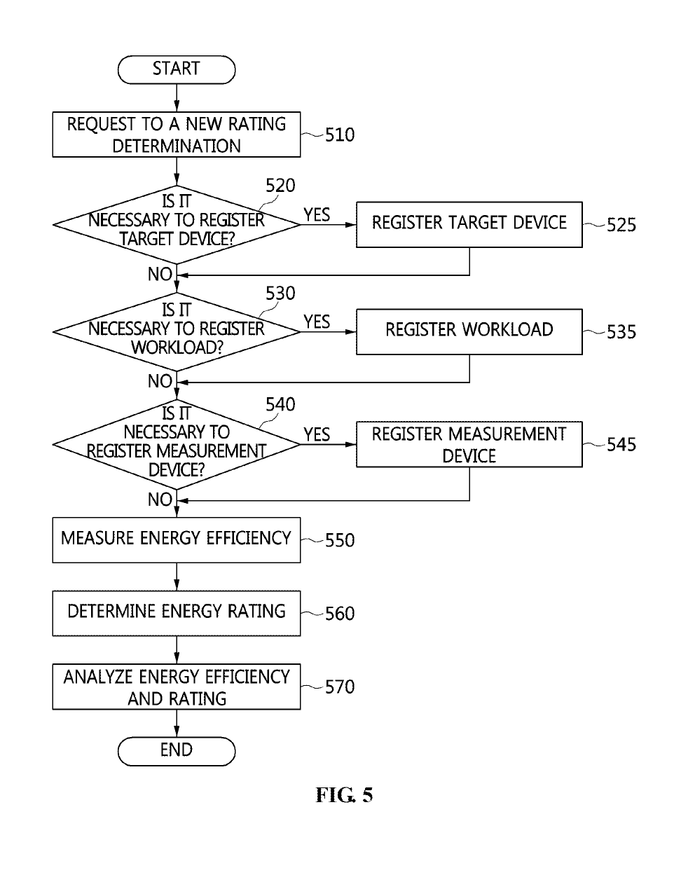

FIG. 5 is a flowchart of a method for evaluating energy efficiency and determining an energy rating according to an embodiment.

At step 510, the energy-rating determination apparatus 110 may receive a request to a new energy rating determination.

At step 520, the energy-rating determination apparatus 110 may determine whether it is necessary to register the target device 120, the energy rating of which is to be determined. When registration of the target device 120 is determined to be necessary, step 525 may be performed. When registration of the target device 120 is determined to be unnecessary, step 530 may be performed.

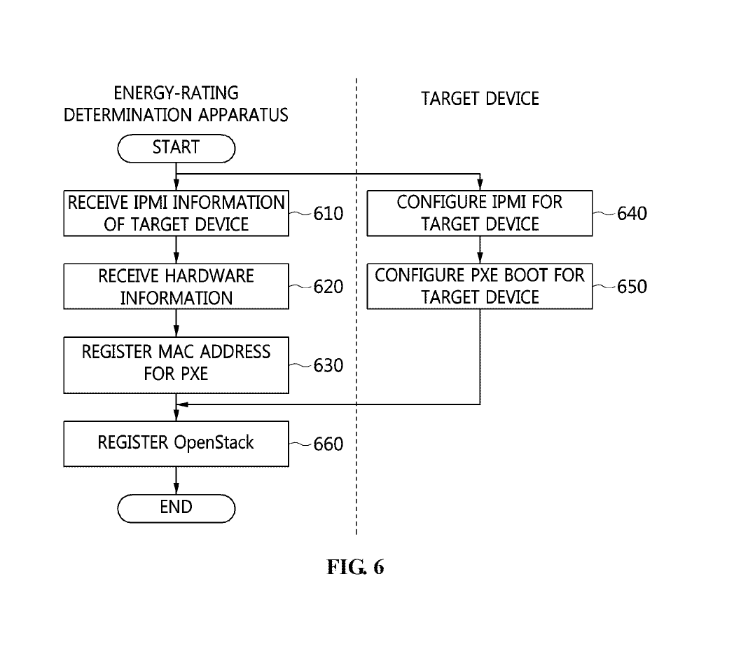

At step 525, the energy-rating determination apparatus 110 may register the target device 120, the energy rating of which is to be determined. The registration of a target device will be described later with reference to FIG. 6.

At step 530, the energy-rating determination apparatus 110 may determine whether it is necessary to register a workload for determining an energy rating. When registration of a workload is determined to be necessary, step 535 may be performed. When registration of a workload is determined to be unnecessary, step 540 may be performed.

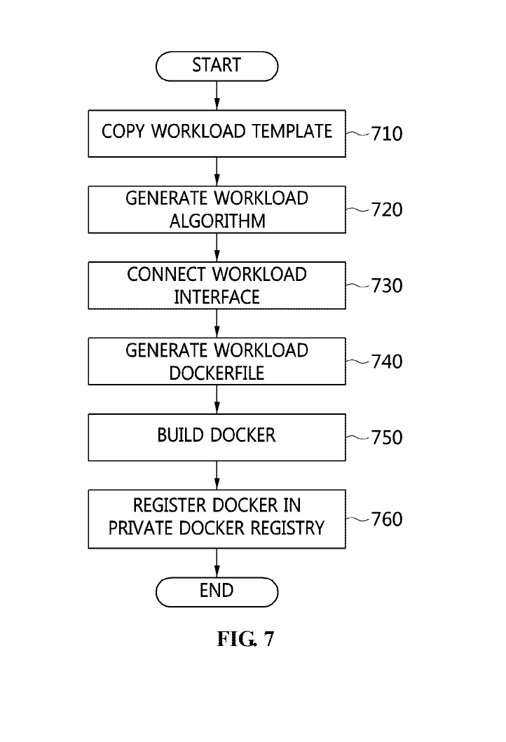

At step 535, the energy-rating determination apparatus 110 may register a workload for determining an energy rating. The registration of a workload will be described later with reference to FIG. 7.

At step 540, the energy-rating determination apparatus 110 may determine whether it is necessary to register a power measurement device 130 for determining an energy rating. When registration of a power measurement device 130 is determined to be necessary, step 545 may be performed. When registration of a power measurement device 130 is determined to be unnecessary, step 550 may be performed.

At step 545, the energy-rating determination apparatus 110 may register a power measurement device 130 for determining an energy rating.

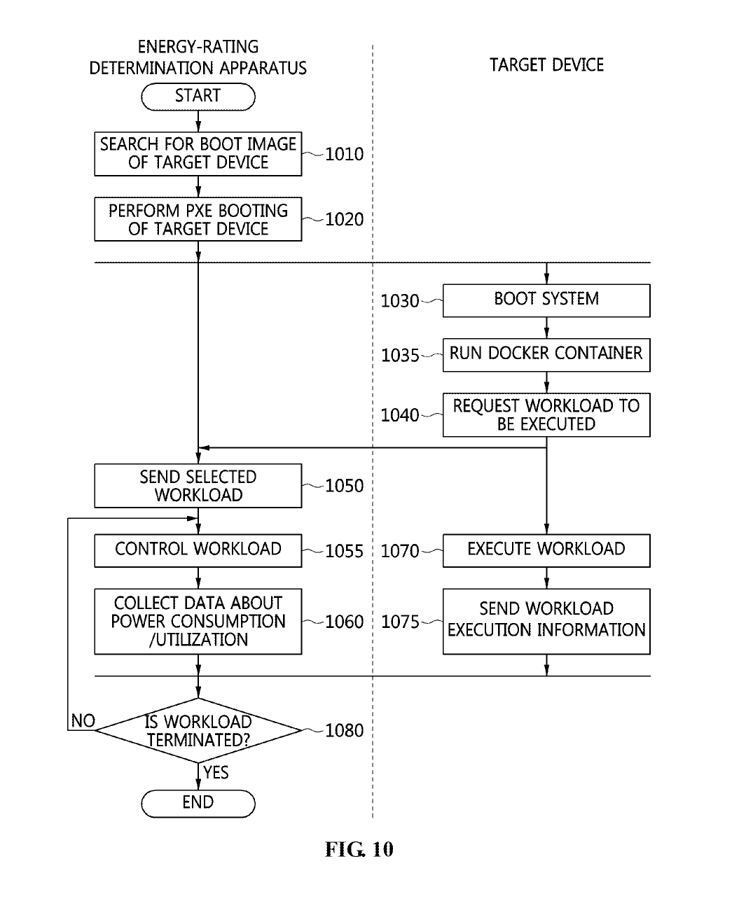

At step 550, the energy-rating determination apparatus 110 may measure the energy efficiency of the target device 120. The measurement of energy efficiency will be described later with reference to FIG. 10.

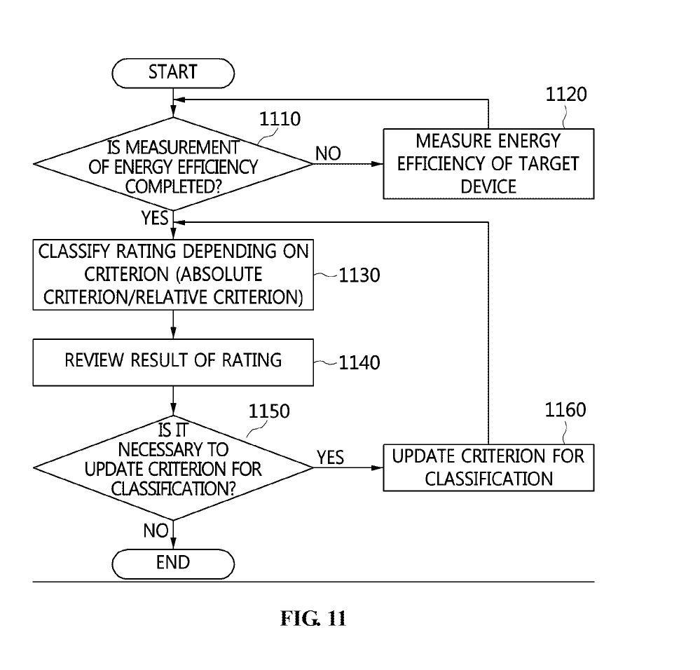

At step 560, the energy-rating determination apparatus 110 may determine the energy rating of the target device 120. The determination of an energy rating will be described later with reference to FIG. 11.

At step 570, the energy-rating determination apparatus 110 may analyze the energy efficiency and the energy rating of the target device 120.

FIG. 6 is a flowchart of a method for registering a target device according to an example.

Step 525, which was described with reference to FIG. 5, may include the following steps 610, 620, 630, 640, 650 and 660.

At step 610, the energy-rating determination apparatus 110 may receive Intelligent Platform Management Interface (IPMI) information of a target device 120.

For example, the IPMI information may include the IPMI address and the IPMI account of the target device 120.

At step 620 the energy-rating determination apparatus 110 may receive hardware information of the target device 120.

For example, the hardware information may include the name of the target device 120 and the Media Access Control (MAC) address of the target device 120.

At step 630, the energy-rating determination apparatus 110 may register the MAC address of the target device 120 for the Preboot eXecution Environment (PXE).

At step 640, the target device 120 may set the IPMI.

At step 650, the target device 120 may set the PXE boot.

At step 660, the energy-rating determination apparatus 110 may automatically register the target device 120 in OpenStack.

When the target device 120 is booted, information about the target device 120 may be updated using the information collection tool of the energy-rating determination apparatus 110.

FIG. 7 is a flowchart of a method for registering a workload according to an example.

Step 535, which was described with reference to FIG. 5, may include the following steps 710, 720, 730, 740, 750 and 760.

A workload may be generated for a selected component. That is, a component, which is the target of the workload to be registered, may be selected from among multiple components.

For example, the selected component may be one of a Central Processing Unit (CPU), memory, a network, and a Graphics Processing Unit (GPU). Also, various components may be added according to a user's purpose.

That is, entities, such as the target device 120, a boot image, a workload set, workloads, components, a power measurement device, and the like, used in the embodiment may be dynamically registered (or added), removed, or configured for a user's purpose and other purposes.

Also, the energy-rating determination apparatus 110 may measure the energy efficiency of the above-described target device 120 for each of the multiple components. The energy-rating determination apparatus 110 may evaluate the energy rating of the above-described target device 120 for each of the multiple components.

The registration of a workload may be performed using a template of the workload. The workload may be executed in a Docker container. Also, the workload may be removed from the target device 120 through communication with the energy-rating determination apparatus 110.

At step 710, the energy-rating determination apparatus 110 may copy a workload template for the workload to be added.

At step 720, the energy-rating determination apparatus 110 may generate a workload algorithm for the workload to be added.

At step 730 the energy-rating determination apparatus 110 may connect a workload interface to the workload to be added.

At step 740, the energy-rating determination apparatus 110 may generate a Dockerfile for the workload to be added.

At step 750, the energy-rating determination apparatus 110 may build the Docker for the workload to be added.

At step 760, the energy-rating determination apparatus 110 may register the Docker in a private docker registry.

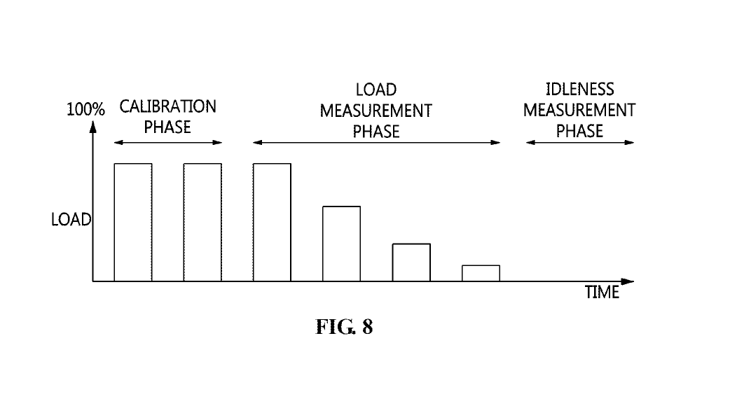

FIG. 8 shows the execution of a workload according to an example.

A workload for the above-described component may include a calibration phase, a load measurement phase, and an idleness measurement phase.

In FIG. 8, loads measured respectively in the calibration phase, the load measurement phase, and the idleness measurement phase are illustrated. Here, the load may be a load factor, the maximum of which is defined as 100%.

In FIG. 8, calibration is illustrated as being performed twice. The number of calibration phases may be configured by a user.

A load factor in the load measurement phase and the number of load measurement phases may be changed depending on the characteristics of the component being analyzed by a user. That is, a load factor in the load measurement phase and the number of load measurement phases involved in the execution of the workload may be determined depending on the characteristics of a component to which the workload pertains.

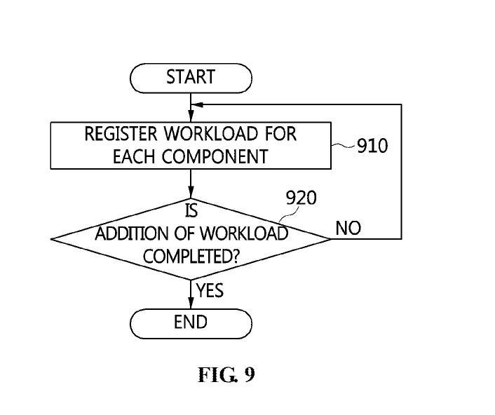

FIG. 9 is a flowchart of a method for registering a workload set according to an example.

The actual measurement of energy efficiency and the determination of an energy rating may be performed for a workload set, rather than a single workload. A workload set may be configured as a group of workloads for various components.

A workload set may include one or more workloads. Each of the one or more workloads may correspond to a single component. That is, the workload set may be a combination of at least one workload for each of multiple components.

One or more of available components may be selected for a workload set depending on the user's purpose, the characteristics of the target device 120, the characteristics of the architecture of the target device 120, and the like. The workload set may include workloads for one or more components.

Step 535, which was described with reference to FIG. 5, may include the following steps 910 and 920.

At step 910, the energy-rating determination apparatus 110 may register a workload for each component.

In order to register a workload for each component, step 910 may be performed for each of multiple components.

For example, step 910 may include steps 710, 720, 730, 740, 750 and 760, which have been described with reference to FIG. 7.

If there are two or more workloads for a single component, step 910 may be repeatedly performed as many times as the number of workloads for the component.

At step 920, the energy-rating determination apparatus 110 may determine whether the addition of workloads for a component set is completed.

When it is determined that the addition of workloads for the component set is not completed, step 910 may be repeated in order to register a workload for another component.

When it is determined that the addition of workloads for the component set is completed, the process may be terminated.

FIG. 10 is a flowchart of a method for measuring the energy efficiency of a target device according to an embodiment.

Step 550, which was described with reference to FIG. 5, may include the following steps 1010, 1020, 1030, 1035, 1040, 1050, 1055, 1060, 1070, 1075 and 1080.

At step 1010, the energy-rating determination apparatus 110 may search for the boot image of the target device 120.

The energy-rating determination apparatus 110 may select a boot image to be used to boot the target device 120 from among multiple boot images registered in the energy-rating determination apparatus 110.

The boot image to be used to boot the target device 120 may be selected depending on the architecture of the target device 120. The energy-rating determination apparatus 110 may select a boot image that matches the architecture of the target device 120 as the boot image to be used to boot the target device 120 from among the multiple boot images registered in the energy-rating determination apparatus 110. Alternatively, the boot image may be selected depending on the architecture of the target device 120 from among the multiple boot images registered in the energy-rating determination apparatus 110.

The boot image may include an Operating System (OS) and a Docker container.

At step 1020, the energy-rating determination apparatus 110 may perform PXE booting of the target device 120 using the selected boot image.

The energy-rating determination apparatus 110 may provide the target device 120 with a boot image that includes an OS.

The boot image and the OS may be selected based on the architecture of the target device 120.

At step 1030, the target device 120 may boot the system thereof using the boot image. The OS may be booted on the target device 120 using PXE.

When booting of the OS is completed in the target device 120, the energy-rating determination apparatus 110 may perform configuration for measuring energy efficiency through communication with the target device.

At step 1035, the target device 120 may run the Docker container.

The Docker container may be run when booting of the target device 120 is completed.

At step 1040, the target device 120 may send a request for a workload to be executed therein to the energy-rating determination apparatus 110.

The energy-rating determination apparatus 110 may receive the request for a workload from the target device.

When the Docker container is run on the target device 120 after booting of the OS on the target device 120, the target device 120 may send the request for a workload to the energy-rating determination apparatus 110.

At step 1050, the energy-rating determination apparatus 110 may send a workload image of the requested workload to the target device 120 in response to the request for the workload.

The target device 120 may receive the workload image of the workload from the energy-rating determination apparatus 110.

The requested workload may be sent as a workload Docker image.

Then, the measurement of energy efficiency may start.

At step 1055, when the workload is executed in the target device 120, the energy-rating determination apparatus 110 may control the workload.

The energy-rating determination apparatus 110 may control the workload in real time such that the load factor of the workload matches a target load.

At step 1060, the energy-rating determination apparatus 110 may collect information about power consumption and utilization.

The energy-rating determination apparatus 110 may receive measurement information, which represents the amount of power consumed by the target device 120 for the execution of the workload, from the power measurement device 130. The power measurement device 130 may send the measurement information to the energy-rating determination apparatus 110.

The energy-rating determination apparatus 110 may receive information about the execution of the workload from the target device. The target device 120 may send information about the execution of the workload to the energy-rating determination apparatus 110.

When the workload is executed in the target device 120, the energy-rating determination apparatus 110 may collect, in real time, the measurement information and the workload execution information from the power measurement device 130 and the target device 120, respectively.

While steps 1055 and 1060 are being performed in the energy-rating determination apparatus 110, steps 1070 and 1075 may be performed in the target device 120.

At step 1070, the target device 120 may execute the workload provided by the energy-rating determination apparatus.

At step 1075, the target device 120 may send the workload execution information to the energy-rating determination apparatus 110.

At step 1080, the energy-rating determination apparatus 110 may determine whether processing of the workload is terminated.

When it is determined that processing of the workload is not terminated, step 1055 may be repeated again.

When processing of the workload is terminated, the energy-rating determination apparatus 110 may measure the energy efficiency of the target device 120 depending on information about the executed workload and the amount of power consumed by the target device 120 for the execution of the workload.

For example, based on information about the executed workloads and the amount of power consumed by the target device 120 for the execution of the workloads, the energy-rating determination apparatus 110 may determine the number of workloads executed using power consumed by the target device 120 for a specific component.

FIG. 11 is a flowchart of a method for determining the energy rating of a target device according to an embodiment.

Step 560, which was described with reference to FIG. 5, may include the following steps 1110, 1120, 1130, 1140, 1150 and 1160.

At step 1110, the energy-rating determination apparatus 110 may determine whether the measurement of energy efficiency is completed.

When it is determined that the measurement of energy efficiency is not completed, step 1120 may be performed. When it is determined that the measurement of energy efficiency is completed, step 1130 may be performed.

At step 1120, the energy-rating determination apparatus 110 may measure the energy efficiency of the target device 120.

For example, step 1120 may include steps 1010, 1020, 1030, 1035, 1040, 1050, 1055, 1060, 1070, 1075 and 1080, which have been described with reference to FIG. 10.

At step 1130, the energy-rating determination apparatus 110 may classify the energy rating of the target device 120 based on some criterion.

The energy-rating determination apparatus 110 may determine the energy rating of the target device 120 using the measured energy efficiency of the target device 120 based on the criterion.

For example, the energy-rating determination apparatus 110 may classify the energy rating of the target device 120 based on an absolute or relative criterion, determined by a user for classification.

Here, determination based on a relative criterion may mean that the energy rating is determined using a relative value acquired through comparison with another device, the energy rating of which has previously been evaluated. For example, the energy-rating determination apparatus 110 may determine the energy rating of the target device 120 using a relative value based on the energy efficiency of another device, the energy rating of which has previously been evaluated.

Here, determination based on an absolute criterion may mean that an energy rating is determined using Performance Per Watt (PPW). For example, the energy-rating determination apparatus 110 may determine the energy rating of the target device 120 using PPW.

The energy-rating determination apparatus 110 may calculate PPW using workload execution information and measurement information.

At step 1140, the energy-rating determination apparatus 110 may check the result of determination of the energy rating. For example, the energy-rating determination apparatus 110 may output the result of determination of the energy rating.

At step 1150, the energy-rating determination apparatus 110 may determine whether it is necessary to update a criterion for classifying energy ratings.

For example, a user may review the result of determination of the energy rating, and may input whether it is necessary to update the classification criterion to the energy-rating determination apparatus 110.

For example, if it is more appropriate for the energy rating of the target device 120 to be differently determined so as to have a different result, the energy-rating determination apparatus 110 may update the classification criterion itself such that the energy rating of the target device 120 is adjusted.

When the update of the criterion for classifying energy ratings is determined to be necessary, step 1160 may be performed.

When the update of the criterion for classifying energy ratings is determined to be unnecessary, the process may be terminated.

At step 1160, the energy-rating determination apparatus 110 may update the criterion for classifying energy ratings.

The apparatus described above may be implemented through hardware components, software components, and/or a combination thereof. For example, the system, devices and components described in the embodiments may be implemented using one or more general-purpose computers or special-purpose computers, for example, a processor, a controller, an arithmetic logic unit (ALU), a digital signal processor, a microcomputer, a field programmable array (FPA), a programmable logic unit (PLU), a microprocessor, and any other device capable of executing instructions and responding thereto. The processing device may run an operating system (OS) and one or more software applications executed on the OS. Also, the processing device may access, store, manipulate, process, and create data in response to the execution of the software. For the convenience of description, the processing device is described as a single device, but those having ordinary skill in the art may understand that the processing device may include multiple processing elements and/or multiple forms of processing elements. For example, the processing device may include multiple processors or a single processor and a single controller. Also, other processing configuration such as parallel processors may be available.

Software may include a computer program, code, instructions, or a combination thereof, and may configure a processing device to be operated as desired, or may independently or collectively instruct the processing device to be operated. Software and/or data may be permanently or temporarily embodied in a specific form of machines, components, physical equipment, virtual equipment, computer storage media or devices, or transmitted signal waves in order to be interpreted by a processing device or to provide instructions or data to the processing device. Software may be distributed to computer systems connected with each other via a network, and may be stored or run on distributed method. Software and data may be stored in one or more computer-readable storage media.

The method according to the embodiments may be implemented as program instructions executable by various computer devices, and may be recorded in computer-readable storage media. The computer-readable storage media may separately or collectively include program instructions, data files, data structures, and the like. The program instructions recorded in the media may be specially designed and configured for the embodiment, or may be available by being well known to computer software experts. Examples of the computer-readable storage media includes magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations of the embodiment, and vice-versa.

With regard to the energy efficiency of a target device, there are provided an apparatus and method for automatically booting and configuring the target device, measuring the energy efficiency of the target device, and determining the energy rating of the target device.

There is provided a standardized system, which may solve problems with an existing system, such as a complicated setting process, variation in results depending on a user, and the like, in an automated manner.

There are provided an apparatus and method for adding a workload for a user's purpose or the like.

There are provided an apparatus and method through which the energy rating of a device, such as a server or the like, may be efficiently determined in accordance with a user's purpose by adding a workload.

There are provided an apparatus and method for determining energy ratings of target devices having various architectures by registering and executing a user-specific workload or a workload standardized for various architectures.

Although the embodiments of the present invention have been disclosed for illustrative purposes, those skilled in the art will appreciate that various modifications, additions and substitutions are possible, without departing from the scope and spirit of the invention. For example, if the described techniques are performed in a different order, if the described components, such as systems, architectures, devices, and circuits, are combined or coupled with other components by a method different from the described methods, or if the described components are replaced with other components or equivalents, the results are still to be understood as falling within the scope of the present invention.

What is claimed is:

1. A method for evaluating energy efficiency, comprising:
sending a workload image of a workload to a target device; and
measuring an energy efficiency of the target device depending on an amount of power consumed by the target device for execution of the workload.

2. The method of claim 1, further comprising:
determining an energy rating of the target device based on the measured energy efficiency.

3. The method of clam 2, wherein the energy rating is determined using Performance Per Watt (PPW).

4. The method of claim 2, wherein the energy rating is determined using a relative value acquired based on comparison with another device, an energy efficiency of which has previously been evaluated.

5. The method of claim 1, further comprising:
providing the target device with a boot image including an operating system,
wherein the operating system is booted on the target device through a Preboot eXecution Environment (PXE).

6. The method of claim 5, wherein the boot image is selected depending on an architecture of the target device from among multiple boot images.

7. The method of claim 6, further comprising:
performing configuration for measurement of the energy efficiency through communication with the target device when booting of the operating system is completed.

8. The method of claim 6, further comprising:
receiving a request for the workload from the target device,
wherein:
the boot image includes a Docker container; and
the request for the workload is sent from the target device when the Docker container is run on the target device after the operating system is booted.

9. The method of claim 1, further comprising:
controlling the workload in real time such that a load factor of the workload matches a target load.

10. The method of claim 1, further comprising:
receiving measurement information, which represents power consumption, from a power measurement device.

11. The method of claim 10, further comprising:
receiving workload execution information, which is information about the execution of the workload, from the target device.

12. The method of claim 11, wherein the measurement information and the workload execution information are collected in real time when the workload is executed in the target device.

13. The method of claim 1, wherein:
the energy efficiency is measured for a workload set; and
the workload set is a combination of at least one workload for each of multiple components.

14. The method of claim 1, further comprising:
registering a workload for a selected component,
wherein the selected component is one of a Central Processing Unit (CPU), memory, a network, and a Graphics Processing Unit (GPU).

15. The method of claim 1, wherein the energy efficiency is measured for each of multiple components.

16. The method of claim 1, further comprising:
registering the workload.

17. The method of claim 1, wherein the workload includes a calibration phase, a load measurement phase, and an idleness measurement phase.

18. The method of claim 17, wherein a load factor in the load measurement phase and a number of times the load measurement phase is performed are determined depending on characteristics of a component to which the workload pertains.

19. An electronic apparatus, comprising:
a communication unit for sending a workload to a target device; and
a processing unit for measuring energy efficiency of the target device based on an amount of power consumed by the target device for execution of the workload.

20. A measurement system, comprising:
an energy-rating determination apparatus for sending a workload to a target device and determining an energy rating of the target device depending on an amount of power consumed by the target device for execution of the workload; and
a power measurement device for providing the energy-rating determination apparatus with measurement information about the amount of power consumed by the target device.
